(19) United States
(12) Patent Application Publication
(10) Pub. No.: US 2007/0140927 A1
(43) Pub. Date: Jun. 21, 2007

(54) Reactor for use in upgrading heavy oil admixed with a highly active catalyst composition in a slurry

(75) Inventor: Bruce Reynolds, Martinez, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 11/305,359

(22) Filed: Dec. 16, 2005

(51) Int. Cl. B01J 8/22

(52) U.S. Cl. 422/140; 422/227

(57) ABSTRACT

The instant invention relates to a reactor useful in upgrading heavy oils admixed with a catalyst composition in a slurry. The liquid recirculating reactor of this invention employs a dispersed bubble flow regime, which requires a high liquid to gas ratio. A dispersed bubble flow regime results in more even flow patterns, increasing the amount of liquid that can be upgraded in a single reactor.

### FIELD OF THE INVENTION

The instant invention relates to a reactor useful in upgrading heavy oils admixed with a catalyst composition in a slurry.

### BACKGROUND OF THE INVENTION

A liquid recirculating reactor is highly effective for upgrading heavy oils. Heavy hydrocarbons may be admixed with an active catalyst composition in a slurry form.

Conventional heavy oil upgrading via hydroprocessing uses relatively inefficient large extrudate catalyst pellets to support the reactions. It has long been recognized that there are significant advantages to using a finely divided slurry catalyst for heavy oil upgrading via hydroprocessing. Past attempts to demonstrate slurry heavy oil hydroprocessing on a large scale have relied on upflow reactors employing bubble column technology. However, such reactors suffer from difficulty in maintaining the desired dispersed bubble flow regime necessary for efficient reactor volume utilization. Past problems with bubble column reactors and difficulties in maintaining the desired bubble flow regime has hindered the development of slurry heavy oil upgrading via hydroprocessing.

There are examples in the prior art of upflow reactors used in heavy oil hydroprocessing. U.S. Pat. No. 6,278,034 discloses a process in which a reactor contains a slurry bed, and feed is added at the bottom of the reactor. In the instant invention a slurry and feed mixture is added at the bottom of the reactor. There is no slurry bed already present in the reactor.

U.S. Pat. Nos. 6,454,932 and 6,726,832 disclose hydrocracking of heavy hydrocarbons in upflow reactors containing ebullating catalyst beds in series. The instant invention as noted above, employs a slurry and feed added at the bottom of the reactor.

U.S. Pat. No. 4,684,456 discloses an upflow reactor employing an expanded catalyst bed. The expansion of the bed is automatically controlled by automatically changing the rate of speed of a recycle pump for the reactor. There is no teaching in this patent of the use of such a reactor with a slurry.

U.S. Pat. No. 6,660,157 discloses a process for slurry hydrocracking employing a series of upflow reactors with interstage separation. The reactors are not liquid recirculating reactors, such as those employed in the instant invention.

### SUMMARY OF THE INVENTION

The instant invention relates to a reactor useful in upgrading heavy oils admixed with a catalyst composition in a slurry. The liquid recirculating reactor of this invention employs a dispersed bubble flow regime, which requires a high liquid to gas ratio. A dispersed bubble flow regime results in more even flow patterns, increasing the amount of liquid that can be upgraded in a single reactor.

### BRIEF DESCRIPTION. OF THE FIGURES

FIG. 1 is a schematic of a liquid recirculating reactor.

FIG. 2 is a graph depicting the beneficial effect of higher liquid to gas ratio on maintaining dispersed bubble flow. Lower gas to liquid ratios result in slug flow or gas continuous flow.

### DETAILED DESCRIPTION OF THE INVENTION

The instant invention is a liquid recirculating reactor suitable for hydroconversion employing slurry feeds comprising heavy oil hydrocarbons and catalysts.

Preparation of active slurry catalysts suitable for use in the instant invention are disclosed in the following co-pending applications: U.S. Ser. Nos. 10/938202, 10/938269, 10/938200, 10/938438, and 10/938003. These applications are incorporated by reference. The slurry composition is prepared by a series of steps, involving mixing a Group VIB metal oxide, such as molybdenum and aqueous ammonia to form an aqueous mixture, and sufiding the mixture to form a slurry. The slurry is then promoted with a Group VIII metal. The slurry is then mixed with a heavy hydrocarbon oil and combined with hydrogen gas to produce the active slurry catalyst. The catalyst is kept mixed in storage until combined with feed in a hydroconversion process.

The co-pending applications mentioned above are also suitable for further information on the hydroconversion processes that may be used in this reactor. Hydroconversion processes include thermal hydrocracking, hydrotreating, hydrodesulfurization, hydrodenitrification and hydrodemetalization

The feeds suitable for use in hydroconversion processes of this reactor are selected from the group consisting of atmospheric residuum, vacuum residuum, tar from a solvent deasphalting unit, atmospheric gas oils, vacuum gas oils, deasphalted oils, olefins, oils derived from tar sands or bitumen, oils derived from coal, heavy crude oils,synthetic oils from Fischer-Tropsch processes, and oils derived from recycled wastes and polymers.

The liquid recirculating reactor of this invention is an upflow reactor in which heavy hydrocarbon oil is admixed with a slurry comprising a catalyst and a hydrogen rich gas at elevated pressure and temperature and hydroprocessed (preferably hydrocracked) for the removal of heteratom contaminants, such as sulfur and nitrogen.

Suitable pressures include a range from 1500 to 3500 psia., preferably from 2000 to 3000 psia. Suitable temperatures include a range from 700 to 900 F, preferably from 775 to 850 F.

The reactor generally includes a pump that recirculates liquid from near the top (outlet) of the reactor back to the bottom (inlet), at typically 5-10 times the rate of the incoming heavy oil stream. In slurry catalyst use, the particles are so small (such as 1-10 micron) that liquid recirculation with a pump is not usually necessary to create sufficient motion of the catalyst to obtain a perfectly mixed flow effect.Pumps are used more frequently with extrudate catalyst pellets (typically 1 mm in diameter by 2 mm in length). Material does flow through the pump in the recirculation process, even in slurry catalyst use. The conventional approach to slurry heavy oil hydroprocessing, has been to rely only on the incoming liquid and gas flow to get the desired catalyst motion (called a slurry bubble column). However, a slurry bubble column is limited in its ability to tolerate the large volumes of hydrogen rich gas required for the upgrading. Slurry bubble columns tend to suffer due to bubble coalescence (the formation of large gas bubbles from smaller bubbles). Bubble coalescence creates highly uneven flow patterns in the reactor that significantly reduce performance. The amount of liquid that can be upgraded in a single reactor is limited. The uneconomic use of multiple reactors in parallel is required. In contrast, the liquid recirculating reactor is able to handle higher gas rates (and therefore higher fresh liquid feed rates) than conventional slurry bubble columns, while maintaining dispersed bubble flow. This is due to the beneficial effect that oil to gas ratio (fresh feed plus recirculated liquid ) has on flow regime. The importance of this effect has not previously been appreciated.

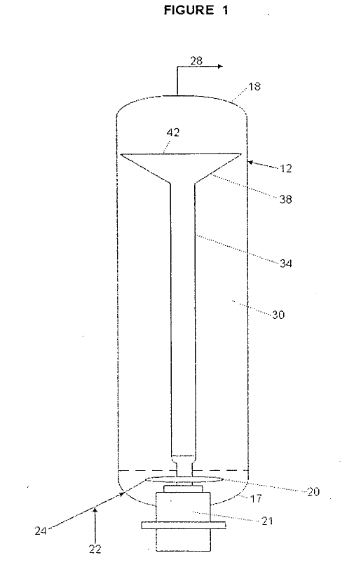

In FIG. 1, a schematic of the preferred embodiment of liquid recirculating reactor is depicted. The reactor 12 comprises a cylinder, having a consistent diameter. The lower end of the reactor 12 is closed off with an end piece 17 while the upper end of the reactor 12 is closed off with a roof 18.

A feed line, 24, which is joined by hydrogen feed line 22, leads into the lower end of the reactor 12,below the inlet distributor tray. The feed comprises a mixture of heavy hydrocarbons and a catalyst slurry, along with hydrogen. The reaction occurs as the hydrocarbon and catalyst slurry mix moves upward from the distributor tray. An overhead product withdrawal line 28 leads from the roof 18. Vapor comprising product and hydrogen, admixed with some slurry is passed overhead to separators, while liquid and slurry is recirculated. Gases are also passed overhead. The liquid product is separated form the catalyst particles either by means of internal separation or by way of external separation. Neither method is shown in this diagram.

A mixing device in the form of a downcomer 34 is located inside the reactor 12. Material not passed overhead is recirculated through the downcomer 34. The downcomer 34 acts to keep the catalyst concentration profile and the temperature profile along the length of the reactor 12 as even as possible, maintaining the bubble flow regime. The downcomer 34 comprises at its upward end a cone 38. The cone 38 contains upcomers which permit gases and liquid to flow upwardly through the cone. The downcomer 34 has an open upper end 42, but the lower end terminates in the inlet of the recirculation pump 21. The outlet of the recirculation pump 21 (not shown) discharges material near the inlet distributor tray 20.

Hydrogen is continuously combined with feed line 24 through the flow line 22. Sufficient hydrogen is introduced so that the superficial gas velocity through the slurry bed 30 is from 2 through 6 cm/s. The slurry bed is typically maintained at a temperature in the range of about 700 through 900 F. Unreacted hydrogen is withdrawn continuously along the flow line 28.This hydrogen can be recycled (not shown).

The cone 38 of the downcomer 34 permits the bulk of the gas bubbles to escape from fluidized slurry that enters the upper end 42 of the downcomer 34. The downcomer 34 transports the degassed slurry to a lower point in the reactor 12.

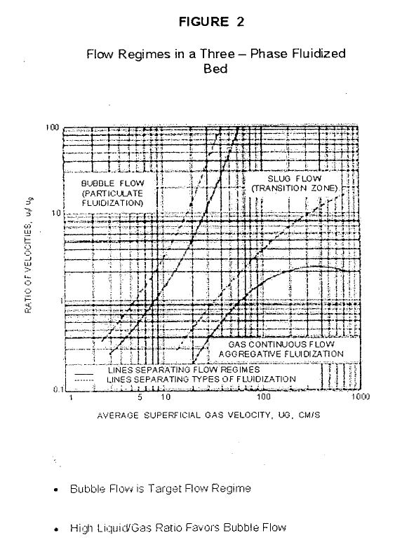

FIG. 2 illustrates the flow regimes in a three-phase fluidized bed. Bubble flow, (particulate fluidization), slug flow (transition zone) and gas continuous flow (aggregative fluidization) are the three phases depicted.Bubble flow, the target flow regime tends to occur in situations where there is high liquid to gas ratio. FIG. 2 illustrates bubble flow occurring in the range of velocity ratios, u_{L}/u_{G} exceeding 1.5 when the average superficial gas velocity is in the range from 2-6 cm/sec.

What is claimed is:

1. An upflow reactor, suitable for use in a process for hydroconversion of heavy oils employing an active slurry catalyst, said reactor having a base and top, and an inlet and an outlet.

2. The reactor of claim 1, wherein the reactor is a liquid recirculating reactor.

3. The liquid recirculating reactor of claim 2, wherein the process for hydroconversion of heavy oils comprises the following steps:
(a) combining, prior to the reactor, a heated heavy oil feed, the active slurry catalyst of claim 1 and a hydrogen-containing gas to form a mixture;
(b) passing the mixture of step (a) through the reactor inlet, into a pipe at the base of the reactor, said pipe moving upward to a distributor tray, said mixture being maintained at elevated temperature and pressure;
(c) removing from the reactor outlet at the top of the reactor, as vapor, a mixture comprising products and hydrogen, as well as unconverted material and slurry catalyst, and passing it to a separator prior to further processing;
(d) recirculating material not passed overhead by means of a downcomer.

4. The reactor of claim 2 in which the liquid recirculating reactor maintains dispersed bubble flow.

5. The reactor of claim 4, in which dispersed bubble flow is effected by high liquid to gas ratio.

6. The reactor of claim 5 in which the velocity ratios, u_{L}/u_{G} exceeds 1.5 when the average superficial gas velocity is in the range from 2 through 6 cm/sec.

7. The reactor of claim 1, which further comprises a pump that recirculates liquid throughout the reactor.

8. The reactor of claim 7, wherein the pump recirculates liquid at typically 5-10 times the rate of the stream entering the reactor inlet.

9. The reactor of claim 1, wherein the active slurry catalyst is prepared by a process comprising the following steps:
(a) mixing a Group VIB metal oxide and aqueous ammonia to form an aqueous mixture;
(b) sufiding the mixture to form a slurry;
(c) mixing the slurry with a heavy hydrocarbon oil and hydrogen gas to produce the active slurry catalyst.

10. The reactor of claim 9, in which the Group VIB metal oxide is molybdenum.

11. The reactor of claim 1, in which the feeds suitable for use in the hydroconversion process of claim 1 are selected from the group consisting of atmospheric residuum, vacuum residuum,tar from a solvent deasphalting unit, atmospheric gas oils, vacuum gas oils, deasphalted oils, olefins, oils derived from tar sands or bitumen, oils derived from coal, heavy crude oils,synthetic oils from Fischer-Tropsch processes, and oils derived from recycled wastes and polymers.

12. The reactor of claim 1, wherein the hydroconversion process is selected from the group consisting of thermal hydrocracking, hydrotreating, hydrodesulfurization, hydrodenitrification and hydrodemetalization.

13. The reactor of claim 1, wherein the hydroconversion process employs a pressure in the range from 1500 to 3500 psia.

14. The reactor of claim 13, wherein the hydroconversion process employs a pressure in the range from 2000 to 3000 psia.

15. The reactor of claim 1, wherein the hydroconversion process employs a temperature range from 700 to 900 F.

16. The reactor of claim 15, wherein the hydroconversion process employs a temperature range from 775 to 850 F.
